(19) United States
(12) Patent Application Publication
(10) Pub. No.: US 2020/0056095 A1
(43) Pub. Date: Feb. 20, 2020

(54) POLYMER-DISPERSED LIQUID CRYSTAL COMPOSITION WITH IMPROVED HEAT RESISTANCE CHARACTERISTICS AND PDLC TYPE LIGHT CONTROL BODY MANUFACTURED THEREFROM

(71) Applicant: VITSWELL CO., LTD, Gimpo-si, Gyeonggi-do (KR)

(72) Inventor: Ji Soo JUN, Gyeonggi-do (KR)

(21) Appl. No.: 16/486,659

(22) PCT Filed: Feb. 14, 2018
(86) PCT No.: PCT/KR2018/001937

§ 371 Date: Oct. 30, 2019

(30) Foreign Application Priority Data
Feb. 17, 2017 (KR) 10-2017-0021423
Nov. 10, 2017 (KR) 10-2017-0149790

(51) Int. Cl. C09K 19/54; G02F 1/1334

(52) U.S. Cl. CPC C09K 19/544; C09K 2019/546; G02F 1/1334

(57) ABSTRACT

A polymer-dispersed liquid crystal composition and a PDLC type light control body using the composition is provided. The polymer-dispersed liquid crystal composition contains a silane-based monomer including at least one acryloyl group, a thiol-based monomer having at least one thiol group, an acryl-based monomer, a liquid crystal mixture, and a light initiator.

### CROSS REFERENCE TO RELATED APPLICATIONS

This application is a National Stage of International Application No. PCT/KR2018/001937, having an International Filing Date of 14 Feb. 2018, which designated the United States of America, and which International Application was published under PCT Article 21(2) as WO Publication No. 2018/151529 A1, which claims priority from and the benefit of Korean Patent Application Nos. 10-2017-0021423, filed on 17 Feb. 2017, and 10-2017-0149790, filed on 10 Nov. 2017, the disclosures of which are incorporated herein by reference in their entireties.

### BACKGROUND

### 1. Field

The present disclosure relates to a polymer-dispersed liquid crystal (PDLC) composition including a silane-based monomer capable of improving high-temperature stability) and a thiol-based monomer and a PDLC-type light control body manufactured therefrom.

### 2. Brief Description of Related Developments

Polymer-dispersed liquid crystals (PDLCs) are liquid crystals in the form of droplets having a size of 1 μm to 3 μm and dispersed in a polymer matrix. The liquid crystals are arranged according to a direction of an electric field applied thereto in response to a voltage applied from the outside to allow light to pass therethrough in the same direction. With no applied voltage, the liquid crystals are randomly arranged to scatter light because the arrangement directions of the liquid crystals are not the same as that of the light.

In general, a PDLC composition includes liquid crystals, an oligomer, a monomer, and a photoinitiator, and the composition is interposed between two transparent films each coated with a transparent electrode. When the composition is exposed to UV light, photocuring reactions between the oligomer and the monomer are initiated by the photoinitiator to form a polymer matrix, and thus the liquid crystals are separated to form droplets.

In the PDLC composition prepared as described above, transmittance in a power-OFF state varies as ambient temperature increases due to a nematic-isotropic phase transition temperature (T_{NI}) of the liquid crystals and a strength difference of the polymer. Due to such variation in transmittance, it is difficult to apply the PDLC composition to automotive and outdoor windows which need to be resistant to high temperatures.

### SUMMARY

Provided are a polymer-dispersed liquid crystal (PDLC) composition for manufacturing a PDLC-type light control body and a PDLC-type light control body, to solve a problems of variation in light transmittance in a power-OFF state as ambient temperature increases by improving an adhesive force between a transparent substrate and a polymer-dispersed liquid crystal layer of the PDLC-type light control body and by improving strength of a polymer.

A polymer-dispersed liquid crystal (PDLC) composition according to the present disclosure includes: a silane-based monomer including at least one acryloyl group; a thiol-based monomer including at least one thiol group; an acrylic monomer; a liquid crystal mixture; and a photoinitiator.

A PDLC-type light control body according to the present disclosure includes: a first electrode; a second electrode; and a polymer-dispersed liquid crystal layer disposed between the first electrode and the second electrode, wherein the polymer-dispersed liquid crystal layer is formed of the polymer-dispersed liquid crystal composition.

Because the polymer-dispersed liquid crystal composition according to the present disclosure includes a silane-based monomer, which includes both an organic functional group bound to an organic material and a functional group reactive to an inorganic material, as a monomer for improving high-temperature stability, an interfacial binding force with a transparent electrode is improved and strength of the polymer is enhanced due to a high degree of cross-linking via stable binding. Thus, because heat introduced into an inner structure is absorbed, transfer and diffusion of heat are inhibited and high-temperature characteristics of a PDLC-type light control body may be improved. Provided are the polymer-dispersed liquid crystal (PDLC) composition and the PDLC-type light control body.

### BRIEF DESCRIPTION OF DRAWINGS

FIG. 1 schematically illustrates interaction of a silane-based monomer including both an organic functional group bound to an organic material and a functional group reactive to an inorganic material, contained in a polymer-dispersed liquid crystal composition.

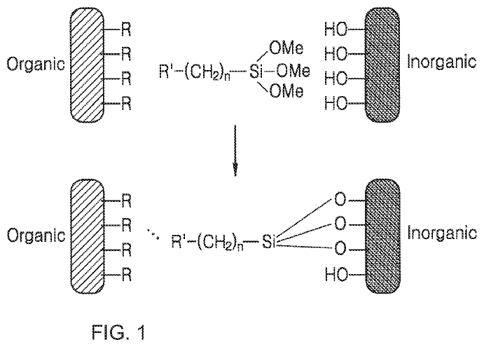

### DETAILED DESCRIPTION

A polymer-dispersed liquid crystal composition according to the present disclosure includes: a silane-based monomer including at least one acryloyl group; a thiol-based monomer including at least one thiol group; an acrylic monomer; a liquid crystal mixture; and a photoinitiator.

The polymer-dispersed liquid crystal composition according to the present disclosure includes a silane-based monomer including at least one acryloyl group.

According to an aspect of disclosed embodiment, the silane-based monomer may be represented by Formula 1 below.

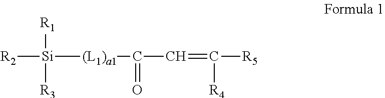

In Formula 1, L₁ is selected from *—O—*′, *—S—*′, a C₁-C₂₀ alkylene group, a C₁-C₂₀ alkenylene group, a C₁-C₂₀ alkynylene group, a divalent C₁-C₂₀ alkoxy group, a divalent C₁-C₂₀ alkylthio group, a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a divalent C₆-C₆₀ aryloxy group, a divalent C₆-C₆₀ arylthio group, a C₁-C₆₀ heteroarylene group, a divalent non-aromatic condensed polycyclic group, and a divalent non-aromatic heterocondensed polycyclic group; and

a C₁-C₂₀ alkylene group, a C₁-C₂₀ alkenylene group, a C₁-C₂₀ alkynylene group, a divalent C₁-C₂₀ alkoxy group, a divalent C₁-C₂₀ alkylthio group, a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a divalent C₆-C₆₀ aryloxy group, a divalent C₆-C₆₀ arylthio group, a C₁-C₆₀ heteroarylene group, a divalent non-aromatic condensed polycyclic group, and a divalent non-aromatic heterocondensed polycyclic group, each substituted with at least one selected from deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, a C₁-C₂₀ alkoxy group, a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₆-C₆₀ aryloxy group, a C₆-C₆₀ arylthio group, a C₁-C₆₀ heteroaryl group, a monovalent non-aromatic condensed polycyclic group, and a monovalent non-aromatic heterocondensed polycyclic group.

According to an aspect of the disclosed embodiment, L₁ may be *—O—*′, *—S—*′, a C₁-C₂₀ alkylene group, a C₁-C₂₀ alkenylene group, a divalent C₁-C₂₀ alkoxy group, or a divalent C₁-C₂₀ alkylthio group.

According to another aspect of the disclosed embodiment, L₁ may be *—O—*′ or a C₁-C₂₀ alkylene group. For example, L₁ may be *—O—*′, an ethylene group, or a propylene group, without being limited thereto.

In Formula 1, a1 is an integer of 0 to 20.

According to an aspect of the disclosed embodiment, the a1 may be an integer of 0 to 10. According to another aspect of the disclosed embodiment, the a1 may be an integer of 1, 2, 3, 4, or 5, without being limited thereto.

For example, in Formula 1 above, a1 may be 1, and L₁ may be a propylene group.

As another example, in Formula 1 above, a1 may be 2, wherein one L₁ may be *—O—*′, and the other L₁ may be a propylene group.

In Formula 1, R₁ to R₅ may be each independently selected from hydrogen, deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, and a C₁-C₂₀ alkoxy group; and

a C₁-C₆₀ alkyl group, a C₂-C₆₀ alkenyl group, a C₂-C₆₀ alkynyl group, and a C₁-C₆₀ alkoxy group, each substituted with at least one selected from deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, a C₁-C₂₀ alkoxy group, a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₆-C₆₀ aryloxy group, a C₆-C₆₀ arylthio group, a C₁-C₆₀ heteroaryl group, a monovalent non-aromatic condensed polycyclic group, and a monovalent non-aromatic heterocondensed polycyclic group.

According to an aspect of the disclosed embodiment, the R₁ to R₃ may be each independently a C₁-C₂₀ alkoxy group. For example, the R₁ to R₃ may be each independently a methoxy group or an ethoxy group.

According to an aspect of the disclosed embodiment, the R₁ to R₃ may be the same. For example, all of the R₁ to R₃ may be methoxy groups, without being limited thereto.

According to another aspect of the disclosed embodiment, the R₄ and R₅ may be each independently selected from

hydrogen, deuterium, —F, —Cl, —Br, —I, a hydroxyl group, a cyano group, a nitro group, an amidino group, a hydrazino group, a hydrazono group, a C₁-C₂₀ alkyl group, and a C₁-C₂₀ alkoxy group; and

a C₁-C₂₀ alkyl group and a C₁-C₂₀ alkoxy group, each substituted with at least one selected from deuterium, —F, —Cl, —Br, —I, a hydroxyl group, a cyano group, a nitro group, an amidino group, a hydrazino group, and a hydrazono group.

For example, the R₄ and R₅ may be each independently hydrogen, deuterium, —F, —Cl, —Br, —I, a hydroxyl group, a cyano group, a nitro group, an amidino group, a hydrazino group, a hydrazono group, a methyl group, an ethyl group, a propyl group, a tert-butyl group, or a C₁-C₂₀ alkoxy group.

According to an aspect of the disclosed embodiment, both of the R₄ and R₅ may be hydrogen, without being limited thereto.

In Formula 1 above, * and *′ are binding sites with an adjacent atom, respectively.

According to an aspect of the disclosed embodiment, the silane-based monomer may be a compound represented by the following formula.

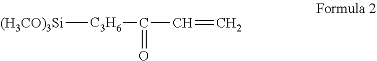

According to an aspect of the disclosed embodiment, an amount of the silane-based monomer may be in the range of 1 part by weight to 10 parts by weight based on 100 parts by weight of the polymer-dispersed liquid crystal composition. For example, the amount of the silane-based monomer may be in the range of 1 part by weight to 6 parts by weight based on 100 parts by weight of the polymer-dispersed liquid crystal composition. Within the amount range of the silane-based monomer, a PDLC-type light control body manufactured using the polymer-dispersed liquid crystal composition has excellent high-temperature characteristics and a high adhesive force.

Particularly, when the amount of the silane-based monomer is in the range of 1 part by weight to 6 parts by weight, high-temperature characteristics and adhesive force are enhanced. When the amount of the silane-based monomer is in the range of 6 parts by weight to 10 parts by weight, high-temperature characteristics and the adhesive force gradually deteriorate.

The silane-based monomer includes at least one photoreactive acryloyl group and may be a compound represented by Formula 1 as shown above.

In addition, when the photoreactive group of the silane-based monomer is a methacryloyl group or a vinyl group instead of the acryloyl group, a photopolymerization behavior of the polymer is very slow resulting in excessive phase separation of the liquid crystals in the polymer matrix, the droplet size significantly increases resulting in an increase in transmittance in a power-OFF state with no voltage applied, and a conversion rate of the polymer decreases resulting in deterioration of strength and high-temperature characteristics of the polymer.

The polymer-dispersed liquid crystal composition according to the present disclosure includes a thiol-based monomer including at least one thiol group.

According to an aspect of the disclosed embodiment, the thiol-based monomer may have a structure represented by Formula 3 below.

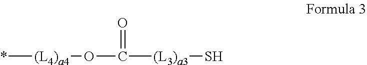

In Formula 3, L₃ and L₄ are each independently selected from a C₁-C₂₀ alkylene group, a C₁-C₂₀ alkenylene group, a C₁-C₂₀ alkynylene group, a divalent C₁-C₂₀ alkoxy group, a divalent C₁-C₂₀ alkylthio group, a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a divalent C₆-C₆₀ aryloxy group, a divalent C₆-C₆₀ arylthio group, a C₁-C₆₀ heteroarylene group, a divalent non-aromatic condensed polycyclic group, and a divalent non-aromatic heterocondensed polycyclic group; and

a C₁-C₂₀ alkenylene group, a C₁-C₂₀ alkylene group, a C₁-C₂₀ alkynylene group, a divalent C₁-C₂₀ alkoxy group, a divalent C₁-C₂₀ alkylthio group, a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a divalent C₆-C₆₀ aryloxy group, a divalent C₆-C₆₀ arylthio group, a C₁-C₆₀ heteroarylene group, a divalent non-aromatic condensed polycyclic group, and a divalent non-aromatic heterocondensed polycyclic group, each substituted with at least one selected from deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, a C₁-C₂₀ alkoxy group, a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₆-C₆₀ aryloxy group, a C₆-C₆₀ arylthio group, a C₁-C₆₀ heteroaryl group, a monovalent non-aromatic condensed polycyclic group, and a monovalent non-aromatic heterocondensed polycyclic group.

According to an aspect of the disclosed embodiment, L₃ and L₄ may be each independently: a C₁-C₂₀ alkylene group; or a C₁-C₂₀ alkylene group substituted with deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkynyl group, or a C₁-C₂₀ alkoxy group.

According to another aspect of the disclosed embodiment, L₃ and L₄ may be each independently a C₁-C₂₀ alkylene group. For example, the L₃ may be a propylene group.

In Formula 3 above, a3 is an integer of 0 to 10.

According to an aspect of the disclosed embodiment, the a3 may be an integer of 0 to 5, without being limited thereto.

In Formula 3 above, a4 is an integer of 0 to 10.

According to an aspect of the disclosed embodiment, the a4 may be an integer of 0 to 5, without being limited thereto.

In Formula 3 above, * is a binding site with an adjacent atom.

According to an aspect of the disclosed embodiment, the thiol-based monomer may include 1 to 4 structures represented by Formula 3 above. For example, the thiol-based monomer may include a compound having one structure represented by Formula 3 above, a compound having three structures respectively represented by Formula 3 above, or any combination thereof.

According to an aspect of the disclosed embodiment, the thiol-based monomer may be represented by Formula 4 below.

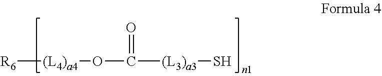

wherein in Formula 4,

L₃, L₄, a3 and a4 are as described above,

n1 is an integer of 1 to 4,

R₆ is selected from: hydrogen, deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, a C₁-C₂₀ alkoxy group, a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₆-C₆₀ aryloxy group, a C₆-C₆₀ arylthio group, a C₁-C₆₀ heteroaryl group, a monovalent non-aromatic condensed polycyclic group, and a monovalent non-aromatic heterocondensed polycyclic group; and

a C₁-C₂₀ alkyl group, a C₂-C₂₀ alkenyl group, a C₂-C₂₀ alkynyl group, a C₁-C₂₀ alkoxy group, a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₆-C₆₀ aryloxy group, a C₆-C₆₀ arylthio group, a C₁-C₆₀ heteroaryl group, a monovalent non-aromatic condensed polycyclic group, and a monovalent non-aromatic heterocondensed polycyclic group, each substituted with at least one selected from deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, a C₁-C₂₀ alkoxy group, a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₆-C₆₀ aryloxy group, a C₆-C₆₀ arylthio group, a C₁-C₆₀ heteroaryl group, a monovalent non-aromatic condensed polycyclic group, and a monovalent non-aromatic heterocondensed polycyclic group.

According to an aspect of the disclosed embodiment, in Formula 4 above, n1 may be 1 to 3. For example, the n1 may be 1 or 3.

According to an aspect of the disclosed embodiment, in Formula 4 above, R₆ may be a C₁-C₂₀ alkyl group. For example, the R₆ may be a methyl group, an ethyl group, a propyl group, an isobutyl group, a sec-butyl group, a ter-butyl group, a pentyl group, an iso-amyl group, or a hexyl group.

According to an aspect of the disclosed embodiment, the thiol-based monomer may include alkyl 3-mercaptopropionate, trimethylolpropane tris(3-mercaptopropionate), or any combination thereof, without being limited thereto.

According to an aspect of the disclosed embodiment, an amount of the thiol-based monomer may be in the range of 10 parts by weight to 40 parts by weight based on 100 parts by weight of the polymer-dispersed liquid crystal composition. When the amount of the thiol-based monomer is within the range above, morphology in the form of droplets is formed during polymerization to improve strength of the polymer, thereby enhancing high-temperature characteristics thereof. For example, when the amount of the thiol-based monomer is less than 10 parts by weight, a polymerization rate of the polymer is so fast that phase separation of the liquid crystal is insufficient in a polymer matrix, resulting in formation of morphology in the form of polymer balls, failing to form morphology in the form of droplets. Thus, when the amount of the thiol-based monomer is less than 10 parts by weight, a driving voltage considerably increases, and the liquid crystals, which are not phase-separated, remain in the polymer matrix in the form of polymer balls, decreasing strength of the polymer thereby deteriorating high-temperature characteristics thereof.

The polymer-dispersed liquid crystal composition according to the present disclosure includes an acrylic monomer.

According to an aspect of the disclosed embodiment, the acrylic monomer may include a monofunctional acrylic monomer and a multifunctional acrylic monomer.

According to an aspect of the disclosed embodiment, the monofunctional acrylic monomer may include methyl acrylate, ethyl acrylate, n-propyl acrylate, isopropyl acrylate, n-butyl acrylate, isoamyl acrylate, isobutyl acrylate, isooctyl acrylate, sec-butyl acrylate, t-butyl acrylate, n-pentyl acrylate, 3-methylbutyl acrylate, n-hexyl acrylate, 2-ethyl-n-hexyl acrylate, n-octyl acrylate, cyclohexyl acrylate, isobornyl acrylate (IBOA), dicyclopentanyl acrylate, dicyclopentanyloxyethyl acrylate, isomyristyl acrylate, lauryl acrylate, methoxydipropyleneglycol acrylate, methoxytripropyleneglycol acrylate, benzyl acrylate, hydroxyethyl acrylate (HEA), hydroxypropyl acrylate, hydroxybutyl acrylate, hydroxypentyl acrylate, hydroxyhexyl acrylate, hydroxycyclohexyl acrylate, or any combination thereof.

For example, the monofunctional acrylic monomer may include hydroxy ethylacrylate (HEA), isobornyl acrylate (IBOA), or any combination thereof, without being limited thereto.

According to an aspect of the disclosed embodiment, the multifunctional acrylic monomer may include ethyleneglycol diacrylate, diethyleneglycol diacrylate, triethyleneglycol diacrylate, tripropyleneglycol diacrylate (TPGDA), propyleneglycol diacrylate, dipropyleneglycol diacrylate, neopentyl glycol diacrylate, 1,4-butanediol diacrylate, 1,6-hexanediol diacrylate, bisphenol A diacrylate, pentaerythritol diacrylate, dipentaerythritol diacrylate, pentaerythritol tri(meth)acrylate, pentaerythritol tetra(meth)acrylate, pentaerythritol hexa(meth)acrylate, dipentaerythritol tri(meth)acrylate, dipentaerythritol penta(meth)acrylate, dipentaerythritol hexa(meth)acrylate, trimethylolpropane tri(meth)acrylate, tris(meth)acryloyloxyethyl phosphate, ethoxylated trimethylolpropane triacrylate, ethoxylated pentaerythritol tetraacrylate, ethoxylated glycerol triacrylate, phosphine oxide (PO) modified glycerol triacrylate, pentaerythritol triacrylate, ethoxylated phosphoric acid triacrylate, trimethylolpropane triacrylate, caprolactone modified trimethylolpropanetriacrylate, ethoxylated trimethylolpropane triacrylate, PO modified trimethylolpropane triacrylate, tris(acryloxyethyl) isocyanurate, dipentaerythritol hexaacrylate, caprolactone modified dipentaerythritol hexaacrylate, dipentaerythritolhydroxy pentaacrylate, alkyl-modified dipentaerythritol pentaacrylate, dipentaerythritol polyacrylate, alkyl-modified dipentaerythritol triacrylate, or any combination thereof.

For example, the multifunctional acrylic monomer may include tripropyleneglycol diacrylate (TPGDA), 1,6-hexanedioldiacrylate (HDDA) or any combination thereof, without being limited thereto.

According to an aspect of the disclosed embodiment, an amount of the acrylic monomer may be in the range of 10 parts by weight to 50 parts by weight based on 100 parts by weight of the polymer-dispersed liquid crystal composition. When the amount of the acrylic monomer is within the range, a proper photopolymerization rate may be maintained to promote phase separation of the liquid crystals, thereby being suitable to increase strength of the polymer and improve high-temperature characteristics thereof. For example, when the amount of the acrylic monomer is less than 10 parts by weight, the photopolymerization rate decreases. When the amount of the acrylic monomer is greater than 50 parts by weight, the photopolymerization rate is so fast as to deteriorate phase separation of the liquid crystals.

According to an aspect of the disclosed embodiment, the acrylic monomer may include hydroxy ethyl acrylate (HEA), isobornyl acrylate (IBOA), 1,6-hexanedioldiacrylate (HDDA), tripropyleneglycol diacrylate (TPGDA), or any combination thereof.

The polymer-dispersed liquid crystal composition according to the present disclosure includes a liquid crystal mixture.

According to an aspect of the disclosed embodiment, the liquid crystal mixture includes a nematic liquid crystal compound. For example, the nematic liquid crystal compound may be, but is not limited to, a biphenyl-based compound, a cyclohexane-based compound, an ester-based compound, a terphenyl-based compound, or a pyrimidine-based compound, and any compound well known in the art may also be used.

A nematic liquid crystal compound generally has a long, thin rod-shaped molecular structure and has a low viscosity because molecules are arranged in parallel with each other and move relatively freely in the major axis direction.

According to an aspect of the disclosed embodiment, a nematic-isotropic phase transition temperature (T_{NI}) of the nematic liquid crystal compound may be 100° C. or higher. As used herein, the term “nematic-isotropic phase transition temperature” refers to a temperature at which phase transition of a liquid crystal mixture including a nematic liquid crystal compound occurs from a nematic phase into an isotropic phase. In general, as the T_{NI} of the liquid crystal mixture increases, variation in a refractive anisotropy (Δn) according to temperature decreases and the nematic phase is maintained in a wider temperature range.

According to an aspect of the disclosed embodiment, the amount of the liquid crystal mixture may be in the range of 30 parts by weight to 70 parts by weight based on 100 parts by weight of the polymer-dispersed liquid crystal composition. When the amount of the liquid crystal mixture is within the range above, phase separation of the liquid crystal occurs while miscibility of the polymer and the liquid crystal is sufficiently maintained, and thus the liquid crystal mixture is suitable for the manufacture of the PDLC-type light control body. For example, when the amount of the liquid crystal mixture is less than 30 parts by weight, phase separation of the liquid crystal does not occur in the polymer matrix. When the amount of the liquid crystal mixture is greater than 70 parts by weight, miscibility between the polymer and the liquid crystal decreases causing phase separation in a solution state failing to prepare the polymer-dispersed liquid crystals.

The polymer-dispersed liquid crystal composition according to the present disclosure includes a photoinitiator.

According to an aspect of the disclosed embodiment, the photoinitiator may include a benzoin ether-based compound, an alkyl phenone-based compound, a benzophenone-based compound, a hydroxy-alkyl benzophenone-based compound (e.g., Darocur series manufactured by Merck), a xanthone-based compound, a thioxanthone-based compound, a phosphineoxide-based compound (e.g., Irgacure series manufactured by Ciba Specialty Chemicals), or derivatives thereof. For example, the photoinitiator may include 2,4,6-trimethylbenzoyl-diphenyl-phosohine oxide, bis(2,4,6-trimethylbenzoyl)-phenylphosphine oxide acrylic monomer, or any combination thereof, without being limited thereto.

According to an aspect of the disclosed embodiment, an amount of the photoinitiator may be in the range of 1 part by weight to 5 parts by weight based on 100 parts by weight of the polymer-dispersed liquid crystal composition. When the amount of the photoinitiator is within the range above, the photoinitiator does not remain after photopolymerization while maintaining a photopolymerization rate of the polymer at a constant level, and thus weather resistance of the polymer does not deteriorate. For example, when the amount of the photoinitiator is less than 1 part by weight, the photopolymerization rate of the polymer is very slow to reduce a conversion rate of the polymer. When the amount of the photoinitiator is greater than 5 parts by weight, the photopolymerization rate of the polymer is very fast and weather resistance of the polymer deteriorate by the photoinitiator remaining after photopolymerization.

According to another aspect of the disclosed embodiment of the present disclosure, provided is a PDLC-type light control body including: a first electrode; a second electrode; and a polymer-dispersed liquid crystal layer disposed between the first electrode and the second electrode, wherein the polymer-dispersed liquid crystal layer is formed of the above-described polymer-dispersed liquid crystal composition.

Materials used to form the first electrode and the second electrode may be any materials well known in the art such as a conductive metal, a conductive polymer, a conductive nanowire, and a metal oxide without limitation.

According to an aspect of the disclosed embodiment, the first electrode and the second electrode may be a transparent electrode, without being limited thereto. For example, one of the first electrode and the second electrode may be a transparent electrode or both of the first electrode and the second electrode may be transparent electrodes.

Materials used to form the transparent electrode may include: a metallic material such as indium tin oxide (ITO) and indium zinc oxide (IZO); glass coated with a conductive polymer such as polyethylene dioxythiophene (PEDOT); or a material coated on a substrate such as triacetyl cellulose, polyimide, polyethylene terephthalate, polyethersulfone, and polystyrene.

According to an aspect of the disclosed embodiment, surfaces of the first electrode and the second electrode may be patterned, if required.

According to an aspect of the disclosed embodiment, the polymer-dispersed liquid crystal layer may be formed by photocuring the polymer-dispersed liquid crystal composition using UV light in a wavelength range of 350 nm to 400 nm.

According to an aspect of the disclosed embodiment, the PDLC-type light control body may be flexible. For example, the first electrode, the second electrode, and the polymer-dispersed liquid crystal layer may be flexible, respectively.

As used herein, the C₁-C₆₀ alkyl group is a monovalent linear or branched aliphatic hydrocarbon group containing 1 to 60 carbon atoms, and examples thereof include a methyl group, an ethyl group, a propyl group, an isobutyl group, a sec-butyl group, a tert-butyl group, a pentyl group, an isoamyl group, and a hexyl group. As used herein, the C₁-C₆₀ alkylene group refers to a divalent group having the same structure as that of the C₁-C₆₀ alkyl group.

As used herein, the C₂-C₆₀ alkenyl group refers to a hydrocarbon group including at least one carbon-carbon double bond within or at a terminal of the C₂-C₆₀ alkyl group, and examples thereof include an ethenyl group, a propenyl group, and a butenyl group. As used herein, the C₂-C₆₀ alkenylene group refers to a divalent group having the same structure as that of the C₂-C₆₀ alkenyl group.

As used herein, the C₂-C₆₀ alkenyl group refers to a hydrocarbon group including at least one carbon-carbon triple bond within or at a terminal of the C₂-C₆₀ alkyl group, and examples thereof include an ethynyl group, a propynyl group, and a butynyl group. As used herein, the C₂-C₆₀ alkynylene group refers to a divalent group having the same structure as that of the C₂-C₆₀ alkynyl group.

As used herein, the C₁-C₆₀ alkoxy group refers to a monovalent group having a chemical formula of —OA₁₀₁ (where A₁₀₁ is the C₁-C₆₀ alkyl group), and examples thereof include a methoxy group, an ethoxy group, and an isopropyloxy group.

As used herein, the C₃-C₁₀ cycloalkyl group refers to a monovalent saturated monocyclic hydrocarbon group containing 3 to 10 carbon atoms, and examples thereof include a cyclopropyl group, a cyclobutyl group, a cyclopentyl group, a cyclohexyl group, and a cycloheptyl group. As used herein, the C₃-C₁₀ cycloalkylene group refers to a divalent group having the same structure as that of the C₃-C₁₀ cycloalkyl group.

As used herein, the C₁-C₁₀ heterocycloalkyl group refers to a monovalent monocyclic group containing 1 to 10 carbon atoms and including at least one hetero atom selected from N, O, Si, P, and S, as a ring-forming atom, and examples thereof include a 1,2,3,4-oxatriazolidinyl group, a tetrahydrofuranyl group, and a tetrahydrothiophenyl group. As used herein, the C₁-C₁₀ heterocycloalkylene group refers to a divalent group having the same structure as the C₁-C₁₀ heterocycloalkyl group.

As used herein, the C₃-C₁₀ cycloalkenyl group refers to a monovalent monocyclic group containing 3 to 10 carbon atoms and including at least one double bond within the ring without aromaticity, and examples thereof include a cyclopentenyl group, a cyclohexenyl group, and a cycloheptenyl group. As used herein, the C₃-C₁₀ cycloalkenylene group refers to a divalent group having the same structure as the C₃-C₁₀ cycloalkenyl group.

As used herein, the C₁-C₁₀ heterocycloalkenyl group refers to a monovalent monocyclic group containing 1 to 10 carbon atoms and including at least one hetero atom selected from N, O, Si, P, and S, as a ring-forming atom, with at least one double bond within the ring. Examples of the C₁-C₁₀ heterocycloalkenyl group include 4,5-dihydro-1,2,3,4-oxatriazolyl group, a 2,3-dihydrofuranyl group, and a 2,3-dihydrothiophenyl group. As used herein, the C₁-C₁₀ heterocycloalkenylene group refers to a divalent group having the same structure as that of the C₁-C₁₀ heterocycloalkenyl group.

As used herein, the C₆-C₆₀ aryl group refers to a monovalent group having a carbocyclic aromatic system containing 6 to 60 carbon atoms, and the C₆-C₆₀ arylene group refers to a divalent group having a carbocyclic aromatic system containing 6 to 60 carbon atoms. Examples of the C₆-C₆₀ aryl group include a phenyl group, a naphthyl group, an anthracenyl group, a phenanthrenyl group, a pyrenyl group, and a chrysenyl group. When the C₆-C₆₀ aryl group and the C₆-C₆₀ arylene group include two or more rings, the two or more rings may be condensed with each other.

As used herein, the C₁-C₆₀ heteroaryl group refers to a monovalent group having a heterocyclic aromatic system containing 1 to 60 carbon atoms and including at least one hetero atom selected from N, O, Si, P, and S as a ring-forming atom, and the C₁-C₆₀ heteroarylene group refers to a divalent group having a heterocyclic aromatic system containing 1 to 60 carbon atoms and including at least one hetero atom selected from N, O, Si, P, and S as a ring-forming atom. Examples of the C₁-C₆₀ heteroaryl group include a pyridinyl group, a pyrimidinyl group, a pyrazinyl group, a pyridazinyl group, a triazinyl group, a quinolinyl group, and an isoquinolinyl group. When the C₁-C₆₀ heteroaryl group and the C₁-C₆₀ heteroarylene group include two or more rings, the two or more rings may be condensed with each other.

As used herein, the C₆-C₆₀ aryloxy group is —OA₁₀₂ (where A₁₀₂ is the C₆-C₆₀ aryl group), and the C₆-C₆₀ arylthio group is —SA₁₀₃ (where A₁₀₃ is the C₆-C₆₀ aryl group).

As used herein, the monovalent non-aromatic condensed polycyclic group refers to a monovalent group containing only carbon atoms (e.g., 8 to 60 carbon atoms), as ring-forming atoms, and having non-aromaticity in which two or more rings are condensed with each other. Examples of the monovalent non-aromatic condensed polycyclic group include a fluorenyl group. As used herein, the divalent non-aromatic condensed polycyclic group refers to a divalent group having the same structure as that of the monovalent non-aromatic condensed polycyclic group.

As used herein, the monovalent non-aromatic heterocondensed polycyclic group refers to a monovalent group (e.g., including 1 to 60 carbon atoms) and at least one hetero atom selected from N, O, Si, P, and S as a ring-forming atom in addition to carbon atoms with non-aromaticity in which two or more rings are condensed with each other. Examples of the monovalent non-aromatic heterocondensed polycyclic group include a carbazolyl group. As used herein, the divalent non-aromatic heterocondensed polycyclic group refers to a divalent group having the same structure as that of the monovalent non-aromatic heterocondensed polycyclic group.

Hereinafter, a polymer-dispersed liquid crystal composition according to an aspect of the presently disclosed embodiment will be described in more detail with reference to the following preparation examples and examples.

### MODE OF DISCLOSURE

### Examples and Comparative Examples

Preparation of Polymer-Dispersed Liquid Crystal Composition for Manufacturing PDLC-Type Light Control Body

Components and weight % thereof used to form polymer-dispersed liquid crystal compositions according to examples and comparative examples are shown in Tables 1, 2, and 3 below.

TABLE 1

| | | Comparative | | | |
|---|---|---|---|---|---|
| | Example | Example | Example | Example | Example |
| | 1-1 | 1-1 | 1-2 | 1-3 | 1-4 |
| Trimethylolpropane | 20 | 20 | 20 | 20 | 20 |
| tris(3-mercaptopropionate) | | | | | |
| Isobornyl acrylate | 8 | 14 | 12 | 10 | 6 |
| Tripropyleneglycol | 15 | 15 | 15 | 15 | 15 |
| diacrylate | | | | | |
| 2,4,6-trimethylbenzoyl- | 1 | 1 | 1 | 1 | 1 |
| diphenyl-phosphine oxide | | | | | |
| Nematic liquid crystal | 50 | 50 | 50 | 50 | 50 |
| compound (T_{NI} = 100° C.) | | | | | |
| 3-acryloxypropyl | 6 | 0 | 2 | 4 | 8 |
| trimethoxysilane | | | | | |
| Total | 100 | 100 | 100 | 100 | 100 |

TABLE 2

| | | Comparative |
|---|---|---|
| | Example | Example |
| | 2-1 | 2-1 |
| Trimethylolpropane | 20 | 20 |
| tris(3-mercaptopropionate) | | |
| Isobornyl acrylate | 8 | 8 |
| Tripropyleneglycol diacrylate | 15 | 15 |
| 2,4,6-trimethylbenzoyl- | 1 | 1 |
| diphenyl-phosphine oxide | | |
| Nematic liquid crystal | 50 | 50 |
| compound (T_{NI} = 100° C.) | | |
| 3-acryloxypropyl | 6 | 0 |
| trimethoxysilane | | |
| 3-methacryloxypropyl | 0 | 0 |
| triethoxysilane | | |
| Vinyl triethoxysilane | 0 | 6 |
| Total | 100 | 100 |

TABLE 3

| | | | Comparative |
|---|---|---|---|
| | Example | Example | Example |
| | 3-1 | 3-2 | 3-1 |
| Trimethylolpropane | 20 | 10 | 0 |
| tris(3-mercaptopropionate) | | | |
| Isobornyl acrylate | 8 | 13 | 18 |
| Tripropyleneglycol diacrylate | 15 | 20 | 25 |
| 2,4,6-trimethylbenzoyl- | 1 | 1 | 1 |
| diphenyl-phosphine oxide | | | |
| Nematic liquid crystal | 50 | 50 | 50 |
| compound (T_{NI} = 100° C.) | | | |
| 3-acryloxypropyl | 6 | 6 | 6 |
| trimethoxysilane | | | |
| Total | 100 | 100 | 100 |

Manufacture of PDLC-Type Light Control Body

The prepared polymer-dispersed liquid crystal composition was coated, to a thickness of 24 μm, on a transparent PET film (188 μm, Toyobo) on which a transparent electrode (indium tin oxide) layer is formed, and a same transparent electrode film was laminated thereon. The structure was exposed to a black light lamp having a wavelength of 365 nm (UV intensity: 1.0 mW/cm²) to prepare a PDLC film.

Evaluation of Adhesive Force and Haze

Adhesive force, Off haze, On haze, and Off haze change temperature of each of the manufactured PDLC-type light control bodies were evaluated according to the following methods, and results thereof are shown in Tables 4, 5, and 6 below.

1) The adhesive force was measured at a peel angle of 180° and a peel rate of 300 mm/min according to the ASTM D4366 method using an H5KS device manufactured by Tinus Olsen.

2) The Off haze and the On haze were measured according to the ASTM D1003 method using a CM-3500d spectrometer manufactured by Minolta.

3) The Off haze change temperature was measured while increasing temperature using the CM-3500d spectrometer manufactured by Minolta.

TABLE 4

| | | | | Off haze change |
|---|---|---|---|---|
| | Adhesive force | Off haze | On haze | temperature |
| | (N/inch) | (%) | (%) | (° C.) |
| Example 1-1 | 2.0 | 90 | 3.2 | 98 |
| Comparative | 0.9 | 90 | 2.9 | 80 |
| Example 1-1 | | | | |
| Example 1-2 | 1.2 | 89 | 3.1 | 87 |
| Example 1-3 | 1.6 | 89 | 3.1 | 93 |
| Example 1-4 | 0.9 | 91 | 3.5 | 88 |

TABLE 5

| | | | | Off haze change |
|---|---|---|---|---|
| | Adhesive force | Off haze | On haze | temperature |
| | (N/inch) | (%) | (%) | (° C.) |
| Example 2-1 | 2.0 | 90 | 3.2 | 98 |
| Comparative | 0.8 | 73 | 3.6 | 81 |
| Example 2-1 | | | | |

TABLE 6

| | | | | Off haze change |
|---|---|---|---|---|
| | Adhesive force | Off haze | On haze | temperature |
| | (N/inch) | (%) | (%) | (° C.) |
| Example 3-1 | 2.0 | 90 | 3.2 | 98 |
| Example 3-2 | 1.5 | 85 | 3.0 | 85 |
| Comparative | 0.9 | 80 | 2.8 | 80 |
| Example 3-1 | | | | |

As shown in Tables 4, 5, and 6, it was confirmed that the PDLC-type light control bodies manufactured by using the polymer-dispersed liquid crystal compositions according to the examples had higher adhesive forces and higher Off haze change temperatures than those of the comparative examples. Particularly, the PDLC-type light control bodies manufactured according to Examples 1-1, 2-1, and 3-1 had high adhesive forces of 2.0 N/inch and exhibited excellent high-temperature characteristics with an Off haze change temperature of 98° C.

What is claimed is:

1. A polymer-dispersed liquid crystal composition comprising:
a silane-based monomer including at least one acryloyl group;
a thiol-based monomer including at least one thiol group;
an acrylic monomer;
a liquid crystal mixture; and
a photoinitiator.

2. The polymer-dispersed liquid crystal composition of claim 1, wherein the silane-based monomer is a compound represented by Formula 1 below: 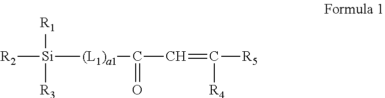
wherein in Formula 1,
L₁ is selected from *—O—*′, *—S—*′, a C₁-C₂₀ alkylene group, a C₁-C₂₀ alkenylene group, a C₁-C₂₀ alkynylene group, a divalent C₁-C₂₀ alkoxy group, a divalent C₁-C₂₀ alkylthio group, a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a divalent C₆-C₆₀ aryloxy group, a divalent C₆-C₆₀ arylthio group, a C₁-C₆₀ heteroarylene group, a divalent non-aromatic condensed polycyclic group, and a divalent non-aromatic heterocondensed polycyclic group; and
a C₁-C₂₀ alkylene group, a C₁-C₂₀ alkenylene group, a C₁-C₂₀ alkynylene group, a divalent C₁-C₂₀ alkoxy group, a divalent C₁-C₂₀ alkylthio group, a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a divalent C₆-C₆₀ aryloxy group, a divalent C₆-C₆₀ arylthio group, a C₁-C₆₀ heteroarylene group, a divalent non-aromatic condensed polycyclic group, and a divalent non-aromatic heterocondensed polycyclic group, each substituted with at least one selected from deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, a C₁-C₂₀ alkoxy group, a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₆-C₆₀ aryloxy group, a C₆-C₆₀ arylthio group, a C₁-C₆₀ heteroaryl group, a monovalent non-aromatic condensed polycyclic group, and a monovalent non-aromatic heterocondensed polycyclic group,
a1 is an integer of 0 to 20,
R₁ to R₅ are each independently selected from hydrogen, deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, and a C₁-C₂₀ alkoxy group; and
a C₁-C₆₀ alkyl group, a C₂-C₆₀ alkenyl group, a C₂-C₆₀ alkynyl group, and a C₁-C₆₀ alkoxy group, each substituted with at least one selected from deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, a C₁-C₂₀ alkoxy group, a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₆-C₆₀ aryloxy group, a C₆-C₆₀ arylthio group, a C₁-C₆₀ heteroaryl group, a monovalent non-aromatic condensed polycyclic group, and a monovalent non-aromatic heterocondensed polycyclic group,
and *′ are binding sites with an adjacent atom, respectively.

3. The polymer-dispersed liquid crystal composition of claim 1, wherein the silane-based monomer is a compound represented by Formula 2 below:

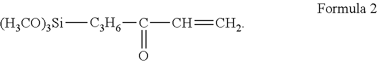

4. The polymer-dispersed liquid crystal composition of claim 1, wherein the thiol-based monomer has a structure represented by Formula 3 below: 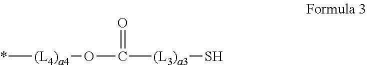
wherein in Formula 3,
L₃ and L₄ are each independently selected from a C₁-C₂₀ alkylene group, a C₁-C₂₀ alkenylene group, a C₁-C₂₀ alkynylene group, a divalent C₁-C₂₀ alkoxy group, a divalent C₁-C₂₀ alkylthio group, a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a divalent C₆-C₆₀ aryloxy group, a divalent C₆-C₆₀ arylthio group, a C₁-C₆₀ heteroarylene group, a divalent non-aromatic condensed polycyclic group, and a divalent non-aromatic heterocondensed polycyclic group; and
a C₁-C₂₀ alkylene group, a C₁-C₂₀ alkenylene group, a C₁-C₂₀ alkynylene group, a divalent C₁-C₂₀ alkoxy group, a divalent C₁-C₂₀ alkylthio group, a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a divalent C₆-C₆₀ aryloxy group, a divalent C₆-C₆₀ arylthio group, a C₁-C₆₀ heteroarylene group, a divalent non-aromatic condensed polycyclic group, and a divalent non-aromatic heterocondensed polycyclic group, each substituted with at least one selected from deuterium, —F, —Cl, —Br, —I, a hydroxyl group, a cyano group, a nitro group, an amidino group, a hydrazino group, a hydrazono group, a C₁-C₂₀ alkyl group, a C₂-C₂₀ alkenyl group, a C₂-C₂₀ alkynyl group, a C₁-C₂₀ alkoxy group, a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₆-C₆₀ aryloxy group, a C₆-C₆₀ arylthio group, a C₁-C₆₀ heteroaryl group, a monovalent non-aromatic condensed polycyclic group, and a monovalent non-aromatic heterocondensed polycyclic group,
a3 is an integer of 0 to 10,
a4 is an integer of 0 to 10, and
* is a binding site with an adjacent atom.

5. The polymer-dispersed liquid crystal composition of claim 1, wherein the thiol-based monomer comprises alkyl 3-mercaptopropionate, trimethylolpropanetris(3-mercaptopropionate), or any combination thereof.

6. The polymer-dispersed liquid crystal composition of claim 1, wherein an amount of the thiol-based monomer is in the range of 10 parts by weight to 40 parts by weight based on 100 parts by weight of the polymer-dispersed liquid crystal composition.

7. The polymer-dispersed liquid crystal composition of claim 1, wherein the acrylic monomer comprises a monofunctional acrylic monomer and a multifunctional acrylic monomer.

8. The polymer-dispersed liquid crystal composition of claim 1, wherein an amount of the acrylic monomer is in the range of 10 parts by weight to 50 parts by weight based on 100 parts by weight of the polymer-dispersed liquid crystal composition.

9. The polymer-dispersed liquid crystal composition of claim 1, wherein the liquid crystal mixture comprises a nematic liquid crystal compound.

10. A polymer-dispersed liquid crystal (PDLC)-type light control body comprising:
a first electrode;
a second electrode; and
a polymer-dispersed liquid crystal layer disposed between the first electrode and the second electrode,
wherein the polymer-dispersed liquid crystal layer is formed of the polymer-dispersed liquid crystal composition according to claim 1.
